(19) United States
(12) Patent Application Publication
(10) Pub. No.: US 2024/0301951 A1
(43) Pub. Date: Sep. 12, 2024

(54) APPARATUS FOR VARIABLE REACTION FORCE USING SPRING

(71) Applicants: Hyundai Motor Company, Seoul (KR); Kia Corporation, Seoul (KR)

(72) Inventors: Sehyun CHANG, Suwon-Si (KR); Youngil SOHN, Yongin-Si (KR); Jun Ho SEONG, Seoul (KR); Woo Keun PARK, Seongnam-Si (KR); Min Jun KIM, Busan (KR); Sang Woo HWANG, Seoul (KR)

(73) Assignees: Hyundai Motor Company, Seoul (KR); Kia Corporation, Seoul (KR)

(21) Appl. No.: 18/381,123

(22) Filed: Oct. 17, 2023

(30) Foreign Application Priority Data
Mar. 6, 2023 (KR) 10-2023-0028901

(51) Int. Cl. F16H 61/688; F16H 3/66; F16H 57/08

(52) U.S. Cl. CPC F16H 61/688; F16H 3/66; F16H 57/082; F16H 2200/2007; F16H 2200/2035

(57) ABSTRACT

A spring reaction force variable apparatus includes, a motor configured to provide rotation force, a clutch unit coupled to an output shaft of the motor, a reducer disposed at an output end portion of the clutch unit, and a spring portion coupled to the reducer. Here, when the motor is driven, rotation force is applied to the reducer coupled to the output end portion, whereby torques are balanced on the reducer, and when the motor is off, the reaction torque of the spring portion and the torque applied to the reducer are balanced.

### CROSS-REFERENCE TO RELATED APPLICATION

The present application claims priority to Korean Patent Application No. 10-2023-0028901, filed on Mar. 6, 2023, the entire contents of which is incorporated herein for all purposes by this reference.

### BACKGROUND OF THE PRESENT DISCLOSURE

### Field of the Present Disclosure

The present disclosure relates to a spring reaction force variable apparatus. More particularly, it relates to a spring reaction force variable apparatus in which reaction force applied to a carrier and torques generated by a spring portion and a motor achieve torque balance.

### Description of Related Art

Generally, a motor is a power generating device configured to receive power to generate rotation force and transmit the generated rotation force via an output shaft, and is widely used in various mechanical devices and industrial fields.

Here, for the case where rotation force variable depending on a situation needs to be output from the motor, the motor may have mounted therein an encoder sensor configured to detect rotation speed of the motor, and a rotation brake and holding device including a brake portion, capable of controlling rotation speed of the motor and various other functions based on information measured by the encoder sensor and engaging braking on the motor when necessary or maintaining stoppage of the motor.

However, the encoder sensor and the brake portion of a rotation braking and holding apparatus provided in the conventional motor are mounted on the motor and the shaft, respectively, and generally, primary processing of the circumference of the shaft is needed to mount thereon the brake portion, and secondary processing of the circumference of the shaft is needed to mount thereon the encoder sensor. For the present reason, a number of processing steps is needed to mount the brake portion and the encoder sensor and a lot of work time and manpower are needed for installation, and thus productivity of the product (motor) is reduced and the unit price is increased, resulting in lower price competitiveness of the product.

Furthermore, due to the structure in which the encoder sensor and the brake portion provided in the conventional motor are respectively mounted on the shaft, there is a problem in that the driving of the brake portion or the driving force of the motor should be continuously applied to maintain torque balance.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a spring portion coupled to a reducer configured to provide reaction force to a torque applied to a planet carrier.

Furthermore, various aspects of the present disclosure are directed to providing a clutch unit in which driving force is applied to a sun gear of a reducer when a motor is driven, and when the motor is off, rotation of the sun gear is restricted using a planet carrier.

Furthermore, still various aspects of the present disclosure are directed to providing a reducer in which reaction force is provided to apply mutually complementary torque to a planet carrier and a spring portion forming the reducer.

The objects of the present disclosure are not limited to the above-mentioned objects, and other objects of the present disclosure not mentioned herein may be understood based on the following description, and may be understood more clearly through the exemplary embodiments of the present disclosure. Furthermore, the objects of the present disclosure may be realized by means and combinations thereof indicated in the claims.

Various aspects of the present disclosure are directed to providing a spring reaction force variable apparatus including a motor configured to provide a torque, a clutch unit connected to an output shaft of the motor, a reducer disposed at an output end of the clutch unit, and a spring portion coupled to the reducer. Here, reaction torque of the spring portion may vary upon driving of the motor.

In an exemplary embodiment of the present disclosure, when the motor is driven, motor torque may be applied to the reducer coupled to the output end portion, whereby the motor torque, the reaction torque of the spring portion, and an external load torque applied to the reducer may be balanced on the reducer, and when the motor is off, the reaction torque and the load torque may be balanced.

In another exemplary embodiment of the present disclosure, the clutch unit may rotate only when torque is input via the output shaft of the motor.

In yet another exemplary embodiment of the present disclosure, the reducer may be implemented as a planetary gear set, and the planetary gear set may include a sun gear coupled to the output end portion of the clutch unit, a ring gear fixed to the spring portion, a plurality of planetary gears disposed between the sun gear and the ring gear, and a planet carrier including a first end portion connected to the planetary gears and a second end portion connected to an external load.

In yet another exemplary embodiment of the present disclosure, the spring portion may include a frame which is stationary so as not to rotate, an elastic portion including a first end portion fixed to the frame, and a ring gear fixing portion coupled to the ring gear and to which a second end portion of the elastic portion is fixed.

In still yet another exemplary embodiment of the present disclosure, the elastic portion may include a first elastic portion adjacent to the frame, and a second elastic portion adjacent to the ring gear.

In a further exemplary embodiment of the present disclosure, the ring gear fixing portion may be coupled to an external end portion of the elastic portion, and the frame may be coupled to a central area of the elastic portion.

In another further exemplary embodiment of the present disclosure, the first elastic portion may include an external end portion coupled to the frame via a spring connecting portion fixed to the frame, the second elastic portion may include an external end portion coupled to the ring gear via a spring connecting portion fixed to the ring gear, and the first elastic portion and the second elastic portion each may have central areas coupled to each other.

In yet another further exemplary embodiment of the present disclosure, an external end portion of the first elastic portion and an external end portion of the second elastic portion may be coupled to each other using a spring connecting portion fixed to the ring gear fixing portion, and a central area of the first elastic portion and a central area of the second elastic portion may be coupled to each other using a spring connecting portion fixed to the frame.

Various aspects of the present disclosure are directed to providing a spring reaction force variable apparatus including a motor configured to provide a torque, a clutch unit connected to an output shaft of the motor, a planetary gear set connected to an output end portion of the clutch unit, a spring portion connected to the planetary gear set, and a controller configured to control driving of the motor and to set driving frequency of the motor. Here, the planetary gear set may include a planet carrier configured to transmit motor torque of the motor or reaction torque of the spring portion to the outside thereof.

In an exemplary embodiment of the present disclosure, the planetary gear set may include a sun gear coupled to the output end portion of the clutch unit, a ring gear fixed to the spring portion, and a plurality of planetary gears connected to the planet carrier and engaged to the sun gear and the ring gear between the sun gear and the ring gear.

In another exemplary embodiment of the present disclosure, the spring portion may include a frame which is stationary so as not to rotate, an elastic portion including a first end portion fixed to the frame, and a ring gear fixing portion coupled to the ring gear and to which a second end portion of the elastic portion is fixed.

In yet another exemplary embodiment of the present disclosure, the ring gear fixing portion may be coupled to an external end portion of the elastic portion, and the frame may be coupled to a central area of the elastic portion.

In yet another exemplary embodiment of the present disclosure, the controller may drive the motor at least once to vary the reaction torque of the spring portion.

In still yet another exemplary embodiment of the present disclosure, when the motor is driven once, the controller may be configured to determine a rotation amount of the planet carrier and then set the driving frequency of the motor based on the determined rotation amount of the planet carrier.

Other aspects and exemplary embodiments of the present disclosure are discussed infra.

It is to be understood that the term “vehicle” or “vehicular” or other similar terms as used herein are inclusive of motor vehicles in general, such as passenger vehicles including sports utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

The above and other features of the present disclosure are discussed infra.

### BRIEF DESCRIPTION OF THE DRAWINGS

FIG. 1 illustrates a detailed configuration of a spring reaction force variable apparatus, as an exemplary embodiment of the present disclosure;

FIG. 2A illustrates the configuration of a spring portion of a spring reaction force variable apparatus, as an exemplary embodiment of the present disclosure;

FIG. 2B illustrates the configuration of a spring portion of a spring reaction force variable apparatus, as an exemplary embodiment of the present disclosure;

FIG. 2C illustrates an operational relationship achieving torque balance upon operation of a motor of a spring reaction force variable apparatus, as an exemplary embodiment of the present disclosure;

FIG. 2D illustrates an operational relationship achieving torque balance in an OFF state of a motor of a spring reaction force variable apparatus, as an exemplary embodiment of the present disclosure;

FIG. 3A illustrates the configuration of a clutch unit of a spring reaction force variable apparatus, as an exemplary embodiment of the present disclosure;

FIG. 3B is an enlarged view of a brake portion and a steel portion of a clutch unit according to various exemplary embodiments of the present disclosure;

FIG. 3C illustrates that driving force of a motor output shaft is applied to a locker, as an exemplary embodiment of the present disclosure;

FIG. 3D illustrates the configuration of a clutch unit in a state in which driving force of a motor output shaft is applied, as an exemplary embodiment of the present disclosure;

FIG. 3E illustrates how an output end rotates in a state in which driving force of a motor output shaft is applied, as an exemplary embodiment of the present disclosure; and

FIG. 4 illustrates the configuration of a clutch unit in a state in which driving force of an output end is applied, as various exemplary embodiments of the present disclosure.

It should be understood that the appended drawings are not necessarily to scale, presenting a somewhat simplified representation of various exemplary features illustrative of the basic principles of the present disclosure. The specific design features of the present disclosure as disclosed herein, including, for example, specific dimensions, orientations, locations, and shapes, will be determined in part by the particular intended application and usage environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, embodiments of the present disclosure will be described in detail with reference to the accompanying drawings. The exemplary embodiments of the present disclosure may be modified into various forms, and the scope of the present disclosure should not be construed as being limited to the following embodiments. The exemplary embodiments are provided to more completely explain in an exemplary embodiment of the present disclosure to those skilled in the art.

Furthermore, terms such as “. portion,” “. unit,” etc. used in the present specification each refer to a unit that processes at least one function or operation, and may be implemented as hardware or a combination thereof.

Furthermore, when a portion is referred to as being “on” or “above” another portion, this includes not only the case where it is “directly on” another portion, but also the case where there is another portion in between. Furthermore, when a portion is referred to as being “beneath” or “under” another portion, this includes not only the case where it is “directly under” another portion, but also the case where there is another portion in between.

Furthermore, a controller 1600 in the present specification may be implemented as a memory that stores algorithms for controlling operation of various components placed in a vehicle or data on a program that reproduces algorithms and a processor that is configured to perform the above described operation using data stored in memory. Here, the memory and the processor may be implemented as separate chips. Alternatively, the memory and the processor may be implemented as a single chip. For example, the controller 1600 may include an electronic control unit (ECU), a central processing unit (CPU), a microprocessor unit (MPU), a micro controller unit (MCU), an application processor (AP) or any type of processor well known in the art of the present disclosure. Furthermore, the controller 1600 may be a combination of software and hardware configured for performing determinations for at least one application or program to execute a method according to exemplary embodiments of the present disclosure.

Furthermore, in each step, the reference number is used for convenience of explanation. The reference number does not describe the order of each step, and each step may be executed differently from the specified order unless a specific order is clearly stated in the context.

Moreover, in the following embodiments, a reducer may be indicated as substantially the same as a planetary gear set, and may be interpreted as including the planetary gear set as a type of reducer.

Various embodiments of the present disclosure relates to a spring reaction force variable apparatus in which rotation force of a motor 1510 disposed at a spring reaction force variable apparatus 1500, reaction force applied via a spring portion, and a torque applied to a planet carrier achieve torque balance.

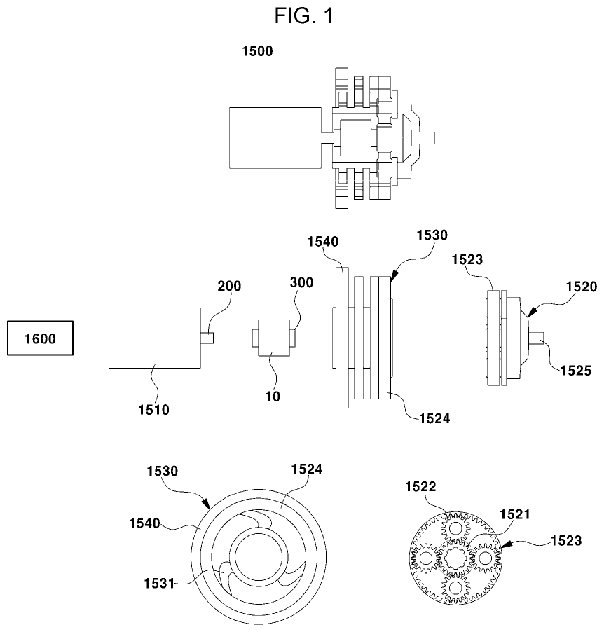

FIG. 1 illustrates the configuration of the spring reaction force variable apparatus 1500, as various exemplary embodiments of the present disclosure.

The spring reaction force variable apparatus 1500 may include the motor 1510 configured to apply rotation force, a clutch unit 10 coupled to an output shaft of the motor 1510, and a reducer 1520 coupled to an output end portion 300 of the clutch unit 10. The reducer 1520 is implemented as a planetary gear set 1520. Here, the planetary gear set 1520 includes a plurality of planetary gears 1522 and a planet carrier 1525 engaged with an external load.

The reducer 1520 may rotate in response to rotation force applied from the output end portion 300 of the clutch unit 10 coupled to the reducer 1520. Moreover, the spring reaction force variable apparatus 1500 includes a spring portion 1530 disposed between a frame 1540 including a non-rotational area and an external side of the reducer 1520. In other words, the spring portion 1530 may have one end portion engaged with a ring gear 1523 located at an external circumference of the reducer 1520 and have another end portion fixed to the frame 1540 which is restricted in rotation. Furthermore, the spring portion 1530 includes an elastic portion 1531 coupled to the frame 1540, and the elastic portion 1531 has another end portion coupled to a ring gear fixing portion 1524 disposed at the ring gear 1523. Moreover, the spring portion 1530 may apply a reaction torque applied between the frame 1540 and the ring gear 1523 to the planet carrier 1525 of the reducer 1520.

In other words, a torque applied from the motor 1510 is transmitted to the reducer 1520 via the clutch unit 10, and the reducer 1520 may be configured to determine the position of the planet carrier 1525 of the reducer 1520 based on the resultant force of the elastic force applied by the spring portion 1530. Accordingly, positional relationship between components forming the reducer 1520 is determined to achieve torque balance among the planet carrier 1525 of the reducer 1520, the motor 1510, and a structure coupled to the planet carrier 1525.

In various exemplary embodiments of the present disclosure, the reducer 1520 is implemented as the planetary gear set 1520. Here, the planetary gear set 1520 includes a sun gear 1521 coupled to the output end portion 300 of the clutch unit 10 at a center portion thereof and the ring gear 1523 configured to surround the outermost side of the planet carrier 1525 engaged with an external load. Furthermore, the ring gear 1523 and the sun gear 1521 include the plurality of planetary gears 1522 disposed therebeween. The planet carrier 1525 may be interlocked with an external load structure which needs driving force. The sun gear 1521 coupled to the output end portion 300 may be integrally rotated with the planetary gears 1522 by sitting in the center portion of the planetary gears 1522, and the planet carrier 1525 disposed to surround the ring gear 1523 may be disposed substantially on the same axis as the output end portion 300 of the clutch unit 10.

In other words, rotation force is applied from the output end portion 300 of the clutch unit 10 to the sun gear 1521, and the planetary gears 1522 are rotated in a direction opposite to the sun gear 1521 in response to the rotation of the sun gear 1521. Moreover, the planetary gears 1522 are moved between the ring gear 1523 and the sun gear 1521 so that the planet carrier 1525 is rotated in the same direction as the sun gear 1521. Furthermore, when the planetary gears 1522 are rotated integrally with the planet carrier 1525 as described above, the ring gear 1523 may rotate at a predetermined angle with respect to the frame 1540, and accordingly, the elastic portion 1531 coupled to the ring gear fixing portion 1524 may provide a reaction torque to the ring gear 1523 rotating with respect to the frame 1540.

The spring portion 1530 includes the frame 1540 limited in rotation and the ring gear fixing portion 1524 to be engaged with the ring gear 1523 of the reducer 1520. The frame 1540 and the ring gear fixing portion 1524 may include the elastic portion 1531 disposed therebetween. When the ring gear 1523 rotates, the elastic portion 1531 disposed between the frame 1540 and the ring gear fixing portion 1524 may provide a reaction torque in a direction opposite to the rotation direction of the ring gear 1523 corresponding to the rotation amount of the ring gear 1523. Accordingly, as the rotation amount of the ring gear 1523 increases, the reaction torque applied via the spring portion 1530 may also increase.

When the motor 1510 rotates to drive the sun gear 1521, the elastic portion 1531 may allow a reaction torque to be applied to the ring gear 1523 corresponding to the rotation amount of the ring gear fixing portion 1524 that rotates integrally with the ring gear 1523. Conversely, the elastic portion 1531 may provide a reaction torque corresponding to the rotation amount between the ring gear 1523 and the frame 1540 by the torque applied to the planet carrier 1525 when the motor 1510 is off. In other words, to achieve balance of the torque introduced into the spring reaction force variable apparatus 1500, the elastic portion 1531 provides a reaction torque in a direction opposite to the torque being introduced into the planet carrier 1525.

The elastic portion 1531 may include one or more elastic portions 1531 including different spring constants corresponding to the amount of deformation and a reaction torque, and in various exemplary embodiments of the present disclosure, the elastic portion 1531 may be implemented as a torsional spring, a coil spring, or a torsion spring. Moreover, the elastic portion 1531 may be a combination of one or more different types of springs.

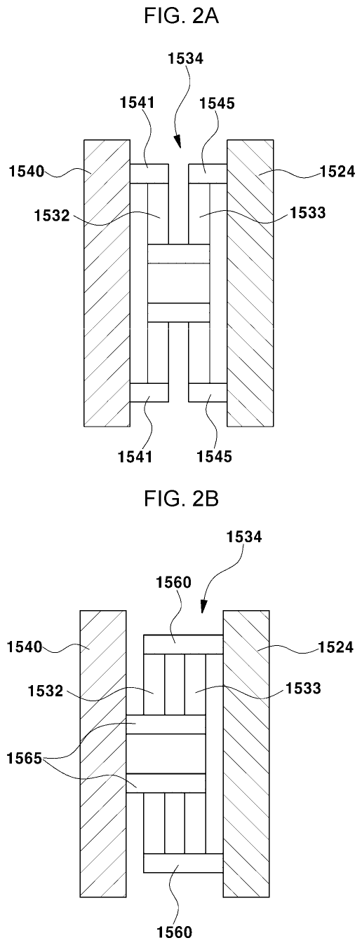

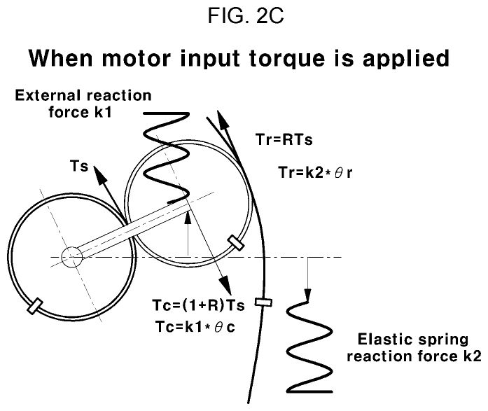

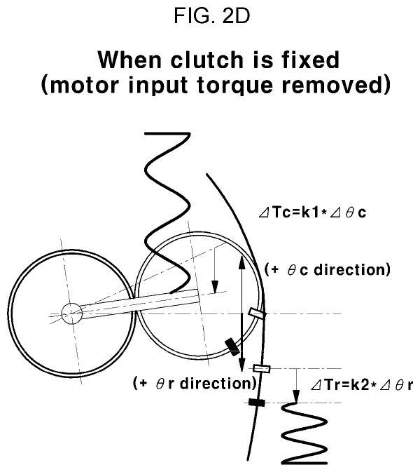

FIG. 2A illustrates a structure in which a first elastic portion 1532 and a second elastic portion 1533, which form the elastic portion 1531, are connected to each other in series to apply reaction torque to the ring gear 1523, as various exemplary embodiments of the present disclosure.

As illustrated in the drawing, the frame 1540 is fixedly disposed so as not to rotate, and includes the first elastic portion 1532 disposed adjacent thereto. The first elastic portion 1532 is coupled to the frame 1540 via a spring connecting portion 1534 which is disposed on the frame 1540. In various exemplary embodiments of the present disclosure, the spring connecting portion 1534 may be coupled to the external end portion of the first elastic portion 1532.

Furthermore, the second elastic portion 1533 is disposed adjacent to the ring gear fixing portion 1524. The second elastic portion 1533 is coupled to the ring gear fixing portion 1524 via a spring connecting portion 1534. The second elastic portion 1533 coupled to the ring gear fixing portion 1524 may include an external end portion disposed to be adjacent to the spring connecting portion 1534.

Moreover, a central area of the first elastic portion 1532 and a central area of the second elastic portion 1533 may be coupled to each other using a spring connecting portion 1534. In other words, the first elastic portion 1532 and the second elastic portion 1533 may be connected to each other in series.

In an exemplary embodiment of the present disclosure, as shown in FIG. 2A, the spring connecting portion 1534 may include a left spring connecting portion 1541 and a right spring connecting portion 1545. As shown in FIG. 2A, external portions of the first elastic portion 1532 and the second elastic portion 1533 are connected to the frame 1540 and the ring gear fixing portion 1524 via the left and right spring connecting portions 1541, 1545, respectively and internal portions of the first elastic portion 1532 and the second elastic portion 1532 are connected to each other.

In an exemplary embodiment of the present disclosure, as shown in FIG. 2B, the spring connecting portion 1534 may include an external spring connecting portion 1560 and an internal spring connecting portion 1565. The internal portions of the first elastic portion 1532 and the second elastic portion 1532 are connected to the frame 1540 via the internal spring connecting portion and external portions of the first elastic portion 1532 and the second elastic portion 1532 are connected to the ring gear fixing portion 1524 via the external spring connecting portion.

Accordingly, when the motor 1510 is driven, rotation force is applied to the sun gear 1521 engaged with the output end portion 300 of the clutch unit 10, whereby the ring gear 1523 is rotated and the frame 1540 and the ring gear fixing portion 1524 are twisted, generating a reaction torque in the elastic portion 1531.

Furthermore, when the motor 1510 is off, the output end portion 300 of the clutch unit 10 is fixed to thereby limit the rotation of the sun gear 1521, and the reaction torque of the elastic portion 1531 coupled to the ring gear fixing portion 1524 and the external torque of a load applied to the planet carrier 1525 are applied to the reducer. Here, the elastic portion 1531 supplies a reaction torque in a direction opposite to the twisting direction thereof. Accordingly, the planet carrier 1525 rotates by an angle smaller than the amount of torque applied from the outside thereof to achieve torque balance.

FIG. 2B illustrates a structure in which the first elastic portion 1532 and the second elastic portion 1533, which form the elastic portion 1531, are connected to each other in parallel to apply reaction torque to the ring gear 1523, as a different embodiment.

As illustrated in the drawing, the first elastic portion 1532 is disposed adjacent to the frame 1540, and the second elastic portion 1533 is disposed adjacent to a side surface of the ring gear 1523. The first elastic portion 1532 and the second elastic portion 1533 are coupled to each other using a spring connecting portion 1534 extending from the side surface of the ring gear 1523. The spring connecting portion 1534 disposed on the side surface of the ring gear 1523 is coupled to the external end portions of the first elastic portion 1532 and the second elastic portion 1533.

Moreover, a spring connecting portion 1534 extending from the frame 1540 is fixed to the central areas of the first elastic portion 1532 and the second elastic portion 1533.

In the different embodiment of the present disclosure, the elastic portion 1531 may apply reaction torque between the ring gear fixing portion 1524 and the frame 1540 when the motor 1510 is driven or is in an OFF state, and thus a torque applied to the planet carrier 1525, a torque generated upon driving of the sun gear 1521, and a reaction torque applied to the ring gear 1523 via the elastic portion 1531 are balanced depending on the operational relationship.

FIG. 2C illustrates a mechanism for balancing torque in response to a driving input of the motor 1510.

The controller 1600 allows the motor 1510 to apply power, and when the output shaft of the motor 1510 rotates, the clutch unit 10 coupled to the output shaft of the motor 1510 may rotate integrally therewith. In the reducer 1520 coupled to the output end portion 300 of the clutch unit 10, the planet carrier 1525 is rotated by the driving force of the output end portion 300 of the clutch unit 10.

The sun gear 1521 coupled to the output end portion 300 of the clutch unit 10 rotates in the same direction as the output end portion 300 of the clutch unit 10, and each of the planetary gears 1522 engaged with the sun gear 1521 rotates in a direction opposite to the sun gear 1521. Moreover, because the planetary gears 1522 move by being located between the sun gear 1521 and the ring gear 1523, the center shaft of the planetary gears 1522 moves in the same direction as the rotation direction of the sun gear 1521. Furthermore, the planet carrier 1525, connected to the planetary gears 1522 and protruding from an external side surface thereof to be coupled to a load, may rotate in the same direction as the movement direction of the center shaft of the planetary gears 1522 and the rotation direction of the sun gear 1521.

Furthermore, when the ring gear 1523 is rotated relative to the frame 1540 in response to the movement of the planetary gears 1522, torsional force is applied to the spring portion 1530 disposed between the frame 1540 and the ring gear fixing portion 1524. For the present reason, the elastic portion 1531 of the spring portion 1530 may apply reaction torque to the ring gear 1523 in response to the relative twist between the frame 1540 and the ring gear fixing portion 1524.

In FIG. 2C, a parallel relationship after achieving torque balance among the outputs of the planet carrier 1525 coupled to the outside thereof, the reducer 1520, and the motor 1510 in response to the input of the motor 1510 is illustrated.

As illustrated in the drawing, the torque of the sun gear 1521 acts in a counterclockwise direction upon driving of the motor 1510, and the reaction torque of the spring portion 1530 coupled to the ring gear 1523 acts in the same direction as the torque of the sun gear 1521. Conversely, reaction torque or torque applied from the planet carrier 1525 acts in a clockwise direction thereof. Accordingly, the sum of the torque of the motor 1510 and the reaction torque of the spring portion 1530 is parallel to the torque of the sun gear 1521.

In other words, when the force applied from the motor 1510 to the sun gear 1521 is Ts and the torque applied to the planet carrier 1525 is Tc, and when the reaction torque of the spring portion 1530 is applied while the ring gear 1523 in a torque balance state is fixed, Tc is determined by multiplying 1+R (wherein, R is the radius of the ring gear and the radius of the sun gear) by the force Ts applied to the sun gear 1521. Furthermore, the reaction torque Tr of the ring gear 1523 has R*Ts.

In FIG. 2C, the Or is a rotation angle of the ring gear 1523 and the θc is a rotation angle of the planet carrier 1525.

Accordingly, as illustrated in the drawing, when torque balance is achieved in response to the input of the motor 1510, it includes a value of Tc=Tr+Ts, and when reaction torque is applied while the ring gear 1523 is fixed, torque balance including a value of Tc=(1+R)*Ts is achieved.

FIG. 2D illustrates, as various exemplary embodiments of the present disclosure, movement to achieve a balance between the reaction torque Tc of the planet carrier 1525 and the reaction torque Tr applied from the outside of the spring reaction force variable apparatus 1500 when the driving force of the motor 1510 is released and the rotation of the output end portion 300 of the clutch unit 10 is limited.

Here, the driving force of the motor 1510 is released, and the torque applied to the sun gear 1521 is zero, which means that the reaction torque of the spring portion 1530 and the torque applied to the planet carrier 1525 are balanced.

As illustrated in the drawing, when the driving of the motor 1510 of the spring reaction force variable apparatus 1500 is released, the output end portion 300 engaged with the sun gear 1521 is converted to a state in which no driving torque is applied from the motor 1510. Accordingly, torque Tc of the planet carrier 1525 to be applied counterclockwise in the drawing is generated, and reaction torque Tr applied via the spring portion 1530 of the spring reaction force variable apparatus 1500 is applied. Here, the reaction torque applied from the outside of the spring reaction force variable apparatus 1500 may include all external factors that affect the spring reaction force variable apparatus 1500 via the planet carrier 1525.

In other words, when the input torque of the motor 1510 is converted to zero after applying the torque Ts of the motor 1510, the sun gear 1521 is fixed by the clutch unit 10, and the planet carrier 1525 connected to the planetary gears 1522 is rotated to find an equilibrium state between Tc and Tr. As an exemplary embodiment of the present disclosure, in a relationship Tc>Tr, the planet carrier 1525 is rotated counterclockwise and restored by the reaction torque Tc, and Tr applied by the spring portion 1530 is increased.

Here, a new torque of the planet carrier 1525 Tc_new and a new torque of the spring portion 1530 Tr_new are determined in relation to the total torque balance of the planetary gears 1522, and a balanced state is Tc_new=Tr_new.

In other words, as illustrated in FIG. 2C, because the torque Ts applied upon driving of the motor 1510 becomes zero and the torque Ts achieves a new balanced state by the torque applied to the spring portion 1530 and the torque output via the planet carrier 1525, torque Ts/2 is applied to each of the spring portion 1530 and the planet carrier 1525. Accordingly, in response to the torque Ts/2 applied in such a manner, the planet carrier 1525 and the ring gear 1523 which is engaged with the spring portion 1530 are adjusted in position.

Moreover, according to the relationship between an elastic modulus K2 of the spring portion 1530 and an elastic modulus K1 applied to the planet carrier 1525, the planet carrier 1525 and the planetary gears 1522 rotate clockwise in the drawing to move to a new balanced position.

In other words, the controller 1600 may be configured to determine the rotation amount (i.e., angle) of the planet carrier 1525 and the planetary gears 1522 in a new torque balance state after turning off the driving of the motor 1510, and set the driving frequency of the motor 1510. Furthermore, the controller 1600 may set the driving frequency of the motor 1510 based on the rotation amount of the planet carrier 1525 rotated in response to the motor 1510 driven one time to determine the rotation amount of the planet carrier 1525.

According to various exemplary embodiments of the present disclosure, the controller 1600 applies, as illustrated in FIG. 2C, the driving force of the motor 1510, is configured to determine the rotation amount of the planet carrier 1525 by performing the step of FIG. 2D in which a new torque balance is achieved, and then repeats the steps of FIG. 2C and FIG. 2D to correspond to the rotation amount of the planet carrier 1525 set in advance.

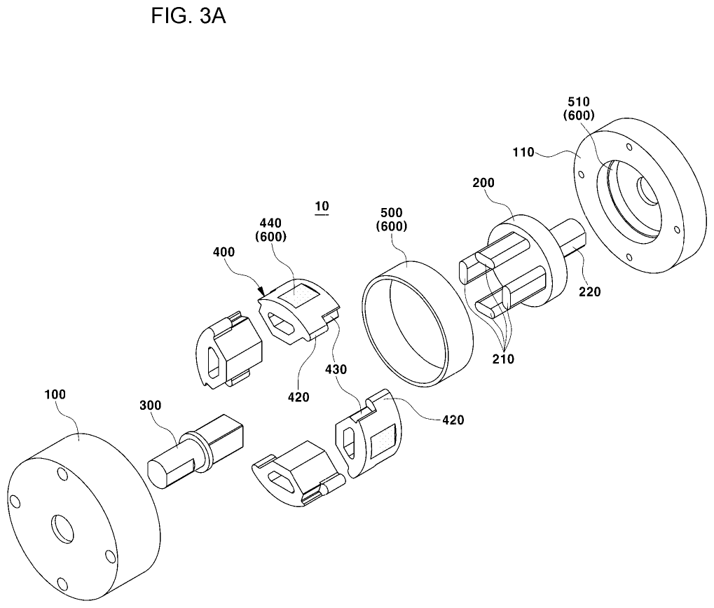

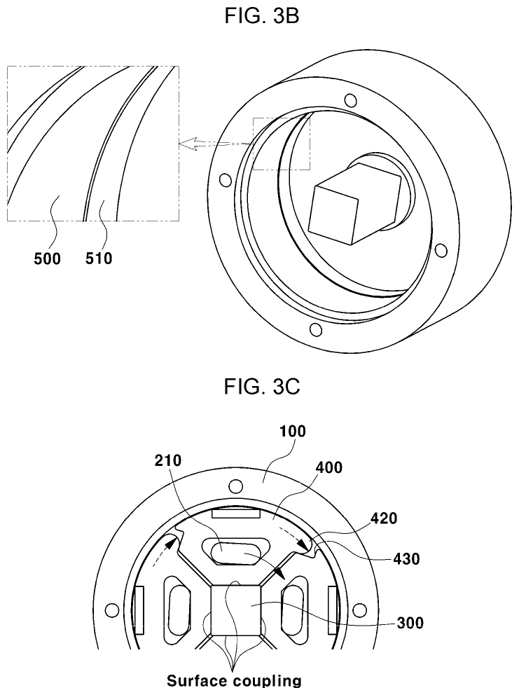

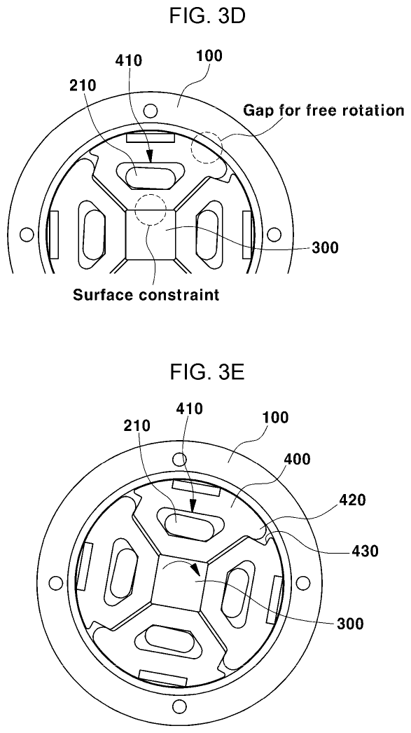

FIG. 3A illustrates the configuration of the clutch unit according to various exemplary embodiments of the present disclosure.

As illustrated in the drawing, the clutch unit 10 includes a housing 100 and cover portion 110, provided at one open end portion of the housing 100 to surround the housing 100. The housing 100 includes a circular cross-section, and the cover portion 110 covers the entire opening at the one end portion of the housing 100.

The clutch unit 10 further includes the output end portion 300 penetrating another end portion of the housing 100 and including at least one flat surface. The housing 100 has an internal side provided with a plurality of lockers 400 surrounding the flat surfaces of the output end portion 300, and a motor output shaft 200 including one end portion inserted into openings 410 each formed in a corresponding one of the lockers 400. The number of the flat surfaces of the output end portion 300 corresponds to the number of lockers 400 disposed at the internal side of the housing 100. The output end portion 300 according to an exemplary embodiment of the present disclosure may have four flat surfaces corresponding to four lockers 400. Moreover, because each of the flat surfaces of the output end portion 300 is brought into contact with a corresponding one of the lockers 400 adjacent thereto when the rotation force of the motor output shaft 200 is applied, the locker 400 and the output end portion 300 may be selectively surface-coupled to each other.

The motor output shaft 200 has one end portion in which at least a portion thereof in the longitudinal direction is inserted into openings 410 each formed in a corresponding one of the lockers 400, and has another end portion including a drive transmitting portion 220 penetrating the cover portion 110 and protruding outwards. The drive transmitting portion 220 is coupled to a driving portion, which applies rotation force, to rotate integrally with the driving portion in the rotation direction of the driving portion.

Moreover, the rotation force of the driving portion may be applied to the drive transmitting portion 220 disposed at the other end portion of the motor output shaft 200, and the driving force applied to the drive transmitting portion 220 may rotate the output end portion 300 through the rotation transmitting portion 210. The driving portion may transmit driving force to rotate the motor output shaft 200, and the plurality of lockers 400 may be surface-coupled to the flat surfaces of the output end portion 300, respectively, in response to the rotation force of the motor output shaft 200. In various exemplary embodiments of the present disclosure, the driving portion coupled to the motor output shaft 200 may be the motor 1510.

Because the motor output shaft 200 includes the rotation transmitting portion 210 inserted into the openings 410 each being formed in a corresponding one of the lockers 400, the motor output shaft 200 includes four rotation transmitting portions 210 corresponding to the four lockers 400 in various exemplary embodiments of the present disclosure, and each of the rotation transmitting portions 210 may maintain the state of being inserted in a corresponding one of the openings 410 formed in each locker 400. Moreover, the rotation transmitting portion 210 is rotated in the same direction as the rotation direction of the drive transmitting portion 220, and the locker 400 brought into contact with the rotation transmitting portion 210 through the opening 410 is integrally rotated therewith in the rotation direction of the motor output shaft 200.

The housing 100 of the clutch portion 10 has an internal side provided with a brake unit 600. Because the brake unit 600 may regulate the movement of the plurality of lockers 400 when the rotation force of the output end portion 300 is applied to the inside of the clutch unit 10, the rotation force of the output end portion 300 may not be transmitted to the motor output shaft 200. The brake unit 600 according to an exemplary embodiment of the present disclosure includes a magnetic portion 440 disposed on the outermost side of the locker 400, a steel portion 500 disposed on the internal circumferential surface of the housing 100 and corresponding to the position of the magnetic portion 440, and a brake portion 510 disposed adjacent to the steel portion 500 and selectively brought into contact with the locker 400.

The plurality of lockers 400 is located inside the housing 100, and the flat surfaces of the output end portion 300 each may be located adjacent to a corresponding one of the lockers 400. The number of the lockers 400 is at least two, and each of the lockers 400 is disposed to include a predetermined gap between the flat surface of the output end portion 300 and the housing 100. The number of flat surfaces of the output end portion 300 may be the same as the number of lockers 400, and the internal side surface of each of the lockers 400 may be disposed adjacent to a corresponding one of the flat surfaces of the output end portion 300.

Furthermore, when the rotation force of the motor output shaft 200 is applied, an internal end portion of the locker 400 is brought into contact with the flat surface of the output end portion 300 and an external circumferential surface of the locker 400 is spaced from the internal circumferential surface of the housing 100 to include a predetermined gap therebetween to integrally rotate with the motor output shaft 200, the locker 400, and the output end portion 300 without interference with the internal circumferential surface of the housing 100.

Because the housing 100 includes the internal circumferential surface provided with the steel portion 500 and at least one locker 400 includes an external circumferential surface including the magnetic portion 440, when the rotation force of the motor output shaft 200 is released, the magnetic portion 440 of the locker 400 may be moved to a position close to the internal circumferential surface of the housing 100. Moreover, because the brake portion 510 adjacent to the steel portion 500 is disposed close to the internal circumferential surface of the housing 100, the external circumferential surface of the locker 400 moves to a position to be brought into contact with the brake portion 510 by magnetic force to thereby limit the movement of the motor output shaft 200.

Furthermore, also in a case where the rotation force of the output end portion 300 is applied, the flat surfaces of the output end portion 300 push the plurality of lockers 400, respectively, in the radial direction to allow the brake portion 510 disposed on the internal circumferential surface of the housing 100 and the external circumferential surface of the locker 400 to fixedly come into contact with each other. Accordingly, transmission of the rotation force of the output end portion 300 to the motor output shaft 200 may be prevented. The brake portion 510 may be provided at a position closer to the locker 400 than to the steel portion 500, and thus the magnetic portion 440 of the locker 400 may be prevented from being brought into direct contact with the steel portion 500.

The locker 400 and the internal circumferential surface of the housing 100 may include a predetermined gap therebetween depending on the position of the locker 400. Accordingly, in a state in which the driving force of the motor output shaft 200 is released, the external circumferential surface of the locker 400 is moved to a position adjacent to the internal circumferential surface of the housing 100 by the magnetic force of the magnetic portion 440 to minimize the gap between the internal circumferential surface of the housing 100 and the external circumferential surface of the locker 400.

Conversely, when the motor output shaft 200 is rotated, the rotation transmitting portion 210 of the motor output shaft 200 is brought into contact with one end portion of the opening in the locker 400 in the widthwise direction thereof, and rotation force may be applied so that each locker 400 is rotated in the rotation direction of the driving portion. Here, each of the lockers 400 is brought into contact with a corresponding flat surface of the output end portion 300, and thus the gap between the internal circumferential surface of the housing 100 and the external circumferential surface of the locker 400 becomes the maximum. Accordingly, in response to the rotation of the motor output shaft 200, the locker 400 is disposed to surface-constrain the output end portion 300 without generating reaction force with the housing 100.

Accordingly, in the clutch unit 10 according to an exemplary embodiment of the present disclosure, the locker 400 may be spaced from the internal circumferential surface of the housing 100 by being disposed at a position corresponding to the motor output shaft 200 and may rotate integrally with the output end portion 300. Here, when the rotation force applied to the motor output shaft 200 is released, the brake portion 510 and the locker 400 may come into contact with each other to limit the movement of the motor output shaft 200 to thereby prevent a “back drive” phenomenon.

FIG. 3B illustrates the steel portion 500 disposed at the internal circumferential surface of the housing 100 and the brake portion 510 disposed adjacent to the steel portion 500.

The steel portion 500 disposed at the internal circumferential surface of the housing 100 and the magnetic portion 440 in the external side of locker 400 face each other. Accordingly, when the rotation force of the motor output shaft 200 is released, the locker 400 may be moved to a position adjacent to the steel portion 500 of the housing 100 by magnetic force. Here, the external side surface of the locker 400 may be brought into contact with the brake portion 510 to limit the movement of the motor output shaft 200.

Furthermore, because the brake portion 510 disposed adjacent to the steel portion 500 may be disposed closer to the center portion of the housing 100 than the steel portion 500, when the locker 400 moves to a position close to the steel portion 500 in response to the magnetic force, the external side surface of the locker 400 may be brought into contact with the brake portion 510.

As illustrated in the drawing, in various exemplary embodiments of the present disclosure, the brake portion 510 may include a predetermined level difference from the steel portion 500, and may be located on at least one of longitudinal opposite end portions of the housing 100 with respect to the steel portion 500. The brake portion 510 may be located on at least a portion of the steel portion 500 in the longitudinal direction and surround the internal circumferential surface of the housing 100.

With the present configuration, even when the locker 400 is moved to a position closest to the internal circumferential surface of the housing 100, the magnetic portion 440 and the steel portion 500 maintain a non-contact state, and reaction force is provided in a state in which the brake portion 510 and the locker 400 are brought into contact with each other.

FIGS. 3C to 3E illustrate that the rotation force of the motor output shaft 200 is applied so that the locker 400 and the output end portion 300 are integrally rotated.

As illustrated in FIG. 3C, when rotation force of the motor 1510, as a driving portion coupled to the drive transmitting portion 220 of the motor output shaft 200, is applied to the motor output shaft 200, the rotation transmitting portions 210 of the motor output shaft 200 each positioned in a corresponding opening 410 in the locker 400 may initially press the opening 410 in the rotation direction of the motor output shaft 200.

The pressed openings 410 move the plurality of lockers 400 so that the external surfaces of the lockers 400 are spaced from the brake portion 510 of the housing 100, and the plurality of lockers 400 is spaced from the internal circumferential surface of the housing 100 and converted into a rotatable state.

The opening 410 includes a trapezoidal shape with a long side thereof being formed at a position close to the external circumferential surface of the housing 100. Here, a side inclined surface of the trapezoidal shape is pressed by the rotation force of the rotation transmitting portion 210. The force is applied to the locker 400 in a tangential direction in which the inclined surface and the rotation transmitting portion 210 come into contact with each other. The force applied to the inclined surface is the resultant force of the vertical force by which the locker 400 constrains the flat surface of the output end portion 300 and the horizontal force by which the locker 400 is rotated.

Moreover, as illustrated in the drawing, the four lockers 400 according to various exemplary embodiments of the present disclosure rotate the rotation transmitting portions 210 each inserted into a corresponding opening 410 in the same direction, and the rotation transmitting portions 210 each apply the rotation force to a corresponding locker 400 in the same direction by being brought into contact with one end portion of the opening 410.

Furthermore, the locker 400 includes a pressing protrusion 420 formed at one end portion of a side surface thereof close to the internal circumferential surface of the housing 100. Moreover, the locker 400 has formed therein an insertion groove 430 into which a pressing protrusion 420 of a locker 400 adjacent thereto is inserted. The pressing protrusion 420 is positioned to cross the insertion groove 430 in the longitudinal direction, and lockers 400 adjacent to each other are mutually coupled using the insertion groove 430 corresponding to the pressing protrusion 420 and the pressing protrusion 420 corresponding to the insertion groove 430.

The lockers 400 each including the pressing protrusion 420 and the insertion groove 430 are mutually coupled to each other. Here, because at least one locker 400 includes the magnetic portion 440, when the corresponding locker 400 is moved adjacent to the internal circumferential surface of the housing 100, all the lockers 400 coupled to each other are moved integrally.

Furthermore, when the rotation force of the rotation transmitting portion 210 is applied, the pressing protrusion 420 applies force to a locker adjacent thereto in a direction in which lockers 400 adjacent to each other are brought into contact with the flat surfaces of the output end portion 300, respectively. In various exemplary embodiments of the present disclosure, when the motor output shaft 200 rotates, the output end portion 300 including four flat surfaces may be surface-coupled to the lockers 400.

Accordingly, when the opening 410 in the locker 400 is pressed by the rotation transmitting portion 210, the pressing protrusion 420 of the locker 400 may be inserted into the insertion groove 430 in a locker 400 adjacent thereto. In other words, the pressing protrusion 420 may press the insertion groove 430 adjacent thereto, and the pressed locker 400 may move a locker 400 adjacent thereto in a direction to be brought into contact with the flat surfaces of the output end portion 300.

Accordingly, when the motor output shaft 200 rotates, the locker 400 presses a locker 400 adjacent thereto and applies force in the same direction as the rotation direction thereof. Furthermore, to press the adjacent locker 400 by the flat surface of the output end portion 300 and the internal side surface of the locker 400 adjacent thereto being brought into contact with each other, there are provided the pressing protrusion 420 and the insertion groove 430.

As illustrated in FIG. 3D, the lockers 400 surface-constrain the output end portion 300 by being brought into contact with the flat surfaces of the output end portion 300, and when at least some of the lockers 400 adjacent to each other are surface-coupled, the flat surfaces of the output end portion 300 are brought into contact with the lockers 400. Moreover, the internal circumferential surface of the housing 100 and the external circumferential surface of the locker 400 are spaced from each other.

Accordingly, rotation force applied to the rotation transmitting portion 210 of the motor output shaft 200 may be transmitted to the locker 400 and to the output end portion 300 without interference with the internal circumferential surface of the housing 100.

Thereafter, as illustrated in FIG. 3E, the motor output shaft 200, the plurality of lockers 400, and the output end portion 300 may be integrally rotated by the rotation force of the motor output shaft 200.

Accordingly, the rotation force of the motor output shaft 200 may be transmitted to the output end portion 300 in response to the clockwise rotation in the drawing.

Accordingly, when the motor 1510 is driven, the rotation torque of the motor output shaft 200 is, as illustrated FIG. 2C, applied to the sun gear 1521, and the torque applied to the sun gear 1521, the reaction torque of the spring portion 1530, and the reaction torque applied to the planet carrier 1525 are balanced.

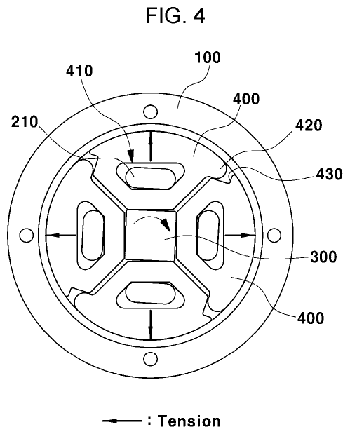

FIG. 4 illustrates the driving relationship in the clutch unit 10 when rotation force is applied to the output end portion 300 in a state in which the rotation force of the motor output shaft 200 is released.

As illustrated in the drawing, when the output end portion 300 rotates, the rotation may provide force to push away the locker 400, adjacent to the output end portion 300, in the radial direction of the housing 100, and the locker 400 may be limited to rotate by being brought into contact with the brake portion 510 disposed at the internal circumferential surface of the housing 100.

In other words, a torque applied to the output end portion 300 by the rotation force may provide force to move the locker 400 in the radial direction of the housing 100 to thereby bring the locker 400 into contact with the brake portion 510. Moreover, the movement of the locker 400 may be limited not only by the rotation force of the output end portion 300 but also by the magnetic force formed between the magnetic portion 440 and the steel portion 500. Accordingly, the rotation force applied to the output end portion 300 may be offset by the reaction force formed between the brake portion 510 and the locker 400, and the torque introduced from the output end portion 300 may not be transmitted to the motor output shaft 200.

In other words, when the sun gear 1521 is rotated to apply the rotation force to the clutch unit 10, the lockers 400 surrounding the output end portion 300 are brought into contact with the brake portion 510 to prevent the rotation force of the output end portion 300 from being transmitted to the motor output shaft 200.

Accordingly, when the motor 1510 is not driven, rotation force applied to the clutch unit 10 via the output end portion 300 of the clutch unit 10 may not be applied to the motor output shaft 200 due to the brake portion 510. Accordingly, as illustrated in FIG. 2D, the torque applied to the reducer by the motor 1510 and the torque transmitted from the reducer to the motor 1510 become zero, and thus a new torque balance is achieved based on the reaction force of the spring portion 1530 located at the reducer and the reaction force applied from the outside thereof engaged with the planet carrier. Furthermore, the planetary gears 1522 and carrier 1525 rotate to move to a position where a new torque balance is achieved.

As is apparent from the above description, various aspects of the present disclosure are directed to providing the following effects.

Various aspects of the present disclosure are directed to providing a spring reaction force variable apparatus that does not need driving force when a motor is off by providing a clutch unit to which a driveshaft of the motor is fixed.

Furthermore, according to an exemplary embodiment of the present disclosure, when the motor is off, torque balance may be maintained by providing reaction force to the torque applied to the spring reaction force variable apparatus via a planet carrier using a spring portion configured to provide reaction force to the torque introduced through the planet carrier.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A spring reaction force variable apparatus comprising:
a motor configured to provide a torque;
a clutch unit connected to an output shaft of the motor;
a reducer disposed at an output end portion of the clutch unit; and
a spring portion coupled to the reducer,
wherein reaction torque of the spring portion is varied according to driving of the motor.

2. The apparatus of claim 1, wherein, when the motor is driven, motor torque is applied to the reducer coupled to the output end portion, whereby the motor torque, the reaction torque of the spring portion, and an external load torque applied to the reducer are balanced on the reducer, and when the motor is off, the reaction torque and the load torque are balanced.

3. The apparatus of claim 1, wherein the clutch unit rotates only when torque is input thereto via the output shaft of the motor.

4. The apparatus of claim 1,
wherein the reducer is implemented as a planetary gear set, and
wherein the planetary gear set includes:
a sun gear coupled to the output end portion of the clutch unit;
a ring gear fixed to the spring portion;
a plurality of planetary gears disposed between the sun gear and the ring gear and engaged thereto; and
a planet carrier including a first end portion connected to the planetary gears and a second end portion connected to an external load.

5. The apparatus of claim 4, wherein the spring portion includes:
a frame which is stationary so as not to rotate;
at least one elastic portion including a first end portion fixed to the frame; and
a ring gear fixing portion coupled to the ring gear and to which a second end portion of the at least one elastic portion is fixed.

6. The apparatus of claim 5, wherein the ring gear fixing portion is coupled to an external end portion of the at least one elastic portion, and the frame is coupled to a central area of the at least one elastic portion.

7. The apparatus of claim 5, wherein the at least one elastic portion includes:
a first elastic portion adjacent to the frame; and
a second elastic portion adjacent to the ring gear.

8. The apparatus of claim 7,
wherein a spring connecting portion includes a first spring connecting portion and a second spring connecting portion,
wherein the first elastic portion includes an external end portion coupled to the frame via the first spring connecting portion fixed to the frame,
wherein the second elastic portion includes an external end portion coupled to the ring gear via the second spring connecting portion fixed to the ring gear fixing portion, and
wherein the first elastic portion and the second elastic portion each have central areas coupled to each other.

9. The apparatus of claim 7,
wherein a spring connecting portion includes a first spring connecting portion and a second spring connecting portion, and
wherein an external end portion of the first elastic portion and an external end portion of the second elastic portion are coupled to each other by the first spring connecting portion fixed to the ring gear fixing portion, and a central area of the first elastic portion and a central area of the second elastic portion are coupled to each other by the second spring connecting portion fixed to the frame.

10. The apparatus of claim 5, wherein the at least one elastic portion includes more than one elastic portion having a different spring constant each other.

11. A spring reaction force variable apparatus comprising:
a motor configured to provide a torque;
a clutch unit connected to an output shaft of the motor;
a planetary gear set connected to an output end portion of the clutch unit;
a spring portion connected to the planetary gear set; and
a controller configured to control driving of the motor and to set driving frequency of the motor,
wherein the planetary gear set includes a planet carrier configured to transmit motor torque of the motor or reaction torque of the spring portion to outside thereof.

12. The apparatus of claim 11, wherein the planetary gear set further includes:
a sun gear coupled to the output end portion of the clutch unit;
a ring gear fixed to the spring portion; and
a plurality of planetary gears connected to the planet carrier and engaged to the sun gear and the ring gear between the sun gear and the ring gear.

13. The apparatus of claim 12, wherein the spring portion includes:
a frame which is stationary so as not to rotate;
at least one elastic portion including a first end portion fixed to the frame; and
a ring gear fixing portion coupled to the ring gear and to which a second end portion of the at least one elastic portion is fixed.

14. The apparatus of claim 13, wherein the ring gear fixing portion is coupled to an external end portion of the at least one elastic portion, and the frame is coupled to a central area of the at least one elastic portion.

15. The apparatus of claim 13, wherein the at least one elastic portion includes:
a first elastic portion adjacent to the frame; and
a second elastic portion adjacent to the ring gear.

16. The apparatus of claim 15,
wherein a spring connecting portion includes a first spring connecting portion and a second spring connecting portion,
wherein the first elastic portion includes an external end portion coupled to the frame via the first spring connecting portion fixed to the frame,
wherein the second elastic portion includes an external end portion coupled to the ring gear via the second spring connecting portion fixed to the ring gear fixing portion, and
wherein the first elastic portion and the second elastic portion each have central areas coupled to each other.

17. The apparatus of claim 15,
wherein a spring connecting portion includes a first spring connecting portion and a second spring connecting portion, and
wherein an external end portion of the first elastic portion and an external end portion of the second elastic portion are coupled to each other by the first spring connecting portion fixed to the ring gear fixing portion, and a central area of the first elastic portion and a central area of the second elastic portion are coupled to each other by the second spring connecting portion fixed to the frame.

18. The apparatus of claim 11, wherein the controller is configured to drive the motor at least once to vary the reaction torque of the spring portion.

19. The apparatus of claim 11, wherein, when the motor is driven once, the controller is configured to determine a rotation amount of the planet carrier and then sets driving frequency of the motor based on the determined rotation amount of the planet carrier.
